(19) United States
(12) Patent Application Publication
(10) Pub. No.: US 2022/0122204 A1
(43) Pub. Date: Apr. 21, 2022

(54) PREDICTIVE PROPERTY MAINTENANCE

(71) Applicant: Wells Fargo Bank, N.A., San Francisco, CA (US)

(72) Inventor: Parul Ghosh, Bangalore (IN)

(21) Appl. No.: 15/919,441

(22) Filed: Mar. 13, 2018

(51) Int. Cl. G06Q 50/16; G06Q 10/00; H04W 4/38; H04W 4/12

(52) U.S. Cl. CPC G06Q 50/163; H04W 4/12; H04W 4/38; G06Q 10/20

(57) ABSTRACT

A method implemented on an electronic computing device includes receiving data from one or more sensing devices at the delinquent property. The data received is used to calculate a maintenance score for the delinquent property. The maintenance score is related to a need for maintenance at the delinquent property. The maintenance score is compared with a benchmark score. Based upon the comparison, a request for maintenance is triggered for the delinquent property.

### BACKGROUND

Properties such as homes and commercial buildings usually can have mortgages that are used to finance the property. Monthly payments are typically due for these mortgages. For various reasons, the monthly payments may not be made and, over a period of time, the properties can become delinquent. When the properties are delinquent for an extended time, the properties can become foreclosed properties.

Foreclosed properties can lose value and also lower sales prices of nearby properties. In addition, when properties become delinquent or foreclosed, maintenance may be neglected for these properties. Further, when foreclosed properties become real-estate owned (REO) properties, for example become owned by an organization that provides the mortgage, providing maintenance for the property can be costly for the organization.

### SUMMARY

Embodiments of the disclosure are directed to a method implemented on an electronic computing device for implementing maintenance for a delinquent property, the method comprising: receiving data from one or more sensing devices at the delinquent property; using the data received to calculate a maintenance score for the delinquent property, the maintenance score being related to a need for maintenance at the delinquent property; comparing the maintenance score with a benchmark score; and based upon the comparison, triggering a request for maintenance for the delinquent property.

In another aspect, a method implemented on an electronic computing device for implementing maintenance for a delinquent property, the method comprising: receiving data from one or more sensing devices at the delinquent property; receiving one or more images of the delinquent property from one or more cameras at or near the delinquent property; identifying a plurality of maintenance categories for the delinquent property; associating each of plurality of maintenance categories with data and/or images from one or more of the one or more sensing devices and the one or more cameras; using the data and the images to calculate a numerical score for each of the plurality of maintenance categories; for each of the plurality of maintenance categories, calculating a deviation between the numerical score and a benchmark score for the maintenance category; calculating a maintenance score for the delinquent property that is equal to a sum of the deviation for each of the maintenance categories; comparing the maintenance score for the delinquent property with a benchmark score for the delinquent property; and when the maintenance score for the delinquent property is a predetermined value at or above the benchmark score for the delinquent property, triggering a request for maintenance at the delinquent property.

In yet another aspect, an electronic computing device comprises: a processing unit; and system memory, the system memory including instructions which, when executed by the processing unit, cause the electronic computing device to: receive data from one or more sensing devices at a delinquent property; receive images from one or more cameras at the delinquent property; associate each image with one or more maintenance categories; based on an analysis of each of the images, determine a maintenance status score for each of the maintenance categories; use the data received and the maintenance status scores for the maintenance categories to calculate a maintenance score for the delinquent property, the maintenance score related to a need for maintenance at the delinquent property; obtain a benchmark score for property maintenance, the benchmark score for property maintenance based on an average of property maintenance scores for homes within a predetermined radius of the delinquent property; compare the maintenance score for the delinquent property with the benchmark score; and based on the comparison, trigger a request for maintenance for the delinquent property.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports predictive maintenance for delinquent properties.

FIG. 2 shows example modules of the predictive maintenance engine of FIG. 1.

FIG. 3 shows an example method for determining when to initiate maintenance at the delinquent property.

FIG. 4 shows an example method for calculating a maintenance score for the delinquent property.

FIG. 5 shows another example method for triggering a maintenance request.

FIG. 6 shows example physical components of the organization server computing device of the system of FIG. 1.

### DETAILED DESCRIPTION

The present disclosure is directed to systems and methods for predicting needed maintenance for delinquent properties and for automatically implementing maintenance procedures at the delinquent properties. As used in this disclosure, a delinquent property is a property for which a mortgage payment has not been made for a predetermined period of time, for example 45 days. Other predetermined periods of time can be used.

Data is received from electronic sensors and cameras at a delinquent property. The electronic sensors can provide data for a plurality of maintenance categories. A maintenance score can be calculated for the delinquent property and compared against a benchmark score. A request for maintenance can be automatically requested when the maintenance score equals or exceeds the benchmark score by a predetermined amount.

Maintenance categories can include categories such as lawn maintenance, roof maintenance, exterior painting or siding maintenance, appliance maintenance, heating and cooling maintenance, snow level and soil moisture and humidity. Other maintenance categories are possible.

Benchmark scores can be compiled from a plurality of factors including average scores for other homes at a predetermined distance from the delinquent property, a regional factor, a climatic factor, a Fannie Mae (Federal National Mortgage Association) benchmark and a current loan state (delinquent or real estate owned (REO)). For example, the Fannie Mae benchmark can be a numerical value that represents a maintenance status of a property at which maintenance is needed. The Fannie Mae benchmark can be modified by the regional factor and climatic factor to take into account a region in which the property is located and climatic conditions in the region. Benchmark scores are discussed in more detail later herein. Other factors are possible.

In some implementations, separate scores can be determined for each maintenance category and deviations can be determined from benchmark scores for each corresponding maintenance categories. In these implementations, the deviations can be added to arrive at an overall maintenance score for the delinquent property.

Delinquent properties can be divided into different groups based upon loan repayment status. For example, in one embodiment described herein, the delinquent properties are divided into three groups—(i) properties that are delinquent for one month, (ii) properties that are delinquent for two months and (iii) properties that are delinquent for three or more months.

Using the systems and methods, when a property has been determined to have been delinquent for a given period of time, such as 60 days, data can be obtained from electronic sensors and imaging devices at the delinquent property. The electronic sensors and imaging devices can be installed at the delinquent property or can supplement electronic sensors and imaging devices that may have been previously installed, for example by the homeowner or builder, at the delinquent property. The electronic sensors are typically Internet of Things (IOT) sensors that permit a direct transmittal of data from the electronic sensors to an electronic computing device that is connected to the Internet. For example, the electronic computing device can be an electronic computing device such as a server computer of an organization that issued the mortgage for the property. The electronic sensors can be used to detect such parameters as temperature and humidity inside the property, soil moisture and whether any pipes or appliances are leaking. Other parameters can be detected.

The imaging devices can be electronic cameras that can be placed at strategic locations both inside and outside the property. For example, the imaging devices can monitor a condition of the lawn, including a height of grass, a condition of a driveway, including a level of snow on the driveway, a condition of the roof of a home on the property and a condition of an exterior of the property. Other status information provided by the imaging devices is possible.

In an example implementation using the systems and methods, a maintenance score is calculated for the delinquent property and the maintenance score is compared against a benchmark score for similar delinquent properties. When a difference between the maintenance score and the benchmark score is at or greater than a predetermined threshold, one or more actions can be taken. In the example implementation, three predetermined thresholds can be used—a low threshold, a moderate threshold and a critical threshold. As discussed in more detail later herein, different actions can be taken depending on the threshold hold level and depending on whether the delinquent property is an REO property.

As an example, when the difference between the maintenance score and the benchmark score is equal to or greater than the moderate threshold and the delinquent property is an REO property, a request for one or more maintenance procedures are automatically triggered for the maintenance category. For example, one maintenance procedure can be to contact a lawn service to request that the lawn be mowed.

As another example, when the difference between the maintenance score and the benchmark score is equal to or greater than the critical threshold and the delinquent property is a REO property, a high-priority maintenance request is issued and an alert is sent to an appropriate authority, for example a federal authority or a fire station. For example, when a determination is made that a pipe is leaking, a high-priority maintenance request can be sent to a plumbing company and a government agency, for example Fannie Mae or the Federal Housing Authority (FHA) can be notified.

The systems and methods disclosed herein are directed to a computer technology that can automatically determine when maintenance is needed for property. Data from sensor devices and imaging devices can be received from the delinquent property to automatically determine a maintenance score for the delinquent property. The maintenance score can be compared against a benchmark score to determine if a threshold is reached for maintenance. Once the threshold is reached, the received data from the sensor devices and imaging devices can be further analyzed to determine where in the property maintenance is needed.

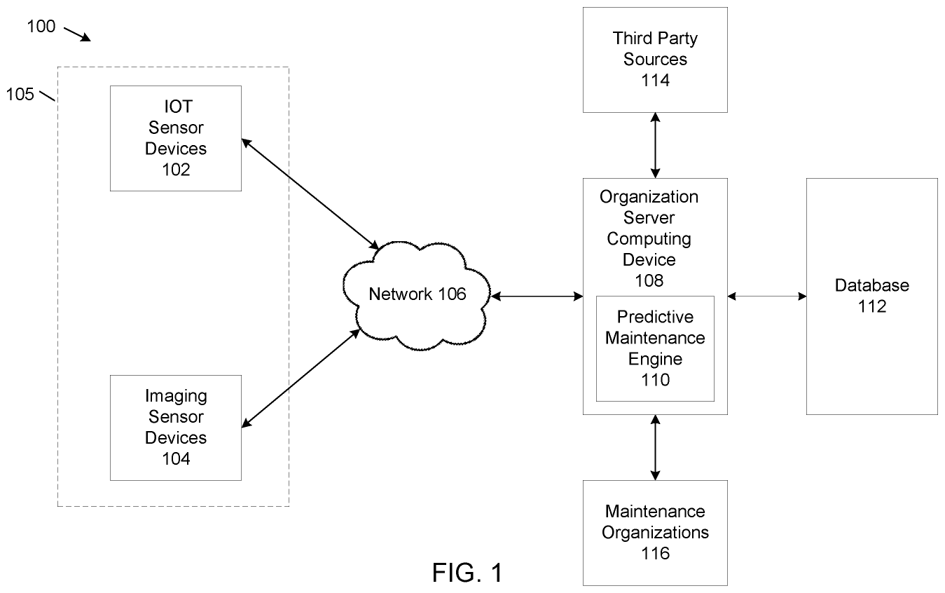

FIG. 1 shows an example system 100 that can support predictive maintenance for delinquent properties. System 100 includes IOT sensor devices 102 and/or imaging sensor devices 104 that can be located at a property 105. The system 100 can also include a network 106, organization server computing device 108, database 112, third party sources 114 and maintenance organizations 116. Organization server computing device 108 includes predictive maintenance engine 110.

The example IOT sensor devices 102 are electronic sensing devices that are capable of connecting directly to the Internet over a wireless connection. IOT sensor devices 102 can be used at the delinquent property to monitor various systems in the property to determine when maintenance is needed for the various systems. IOT sensor devices 102 are typically installed at the delinquent property when the property has been delinquent for at least 60 days. Example IOT sensor devices 102 can include temperature and humidity sensors, pressure sensors, soil moisture sensors and water leak detectors. Other IOT sensor devices 102 are possible.

The example imaging sensor devices 104 are electronic cameras that can be installed at various internal and external locations at the delinquent property. For example, imaging sensor devices 104 can be installed external to the delinquent property to monitor a condition of the roof of the property, siding on property, a condition of the driveway, a condition of the lawn, etc. Imaging sensor devices 104 can be installed internal to the delinquent property to monitor an overall condition of the interior of the delinquent property. Imaging sensor devices 104 can transmit scanned images wirelessly to the Internet over a wireless connection. In some implementations, not shown in FIG. 1, the imaging sensor devices 104 can transmit the scanned images to an electronic computing device at the delinquent property. The electronic computing device can then wirelessly transmit the scanned images over network 106 to organization server computing device 108.

The example network 106 is a computer network and can be any type of wireless network, wired network and cellular network, including the Internet. IOT sensor devices 102 can communicate with organization server computing device 108 using network 106.

The example organization server computing device 108 is a server computer of an organization that issued the mortgage on the delinquent property or that owns the delinquent property, if the delinquent property is REO. Organization server computing device 108 can communicate over network 106 with IOT sensor devices 102, imaging sensor devices 104, third party sources 114 and maintenance organizations 116. Organization server computing device 108 can also communicate with database 112. One example organization is a realty company. Another example organization is a financial institution, such as a bank.

The example predictive maintenance engine 110 receives and processes data from IOT sensor devices 102 and from imaging sensing devices 104. Predictive maintenance engine 110 can also implement a workflow to calculate a maintenance score for delinquent property using the sensor and imaging data received. Predictive maintenance engine 110 also compares the calculated maintenance score with a benchmark score, determines whether maintenance needs to be implemented for the delinquent property and initiates an action to request the needed maintenance. The predictive maintenance engine 110 is described in more detail later herein.

The example third party sources 114 are server computing devices from organizations that can provide information needed to calculate the maintenance score. Some example third party sources 114 can include government organizations that can provide climate data, an expected Fannie Mae benchmark and a regional factor and one or more organizations that can provide benchmark data for other houses within a predetermined radius of the delinquent property. As discussed in more detail later herein, parameters such as a climatic factor and the regional factor can impact the maintenance score.

The example maintenance organizations 116 are organizations that can implement needed maintenance for the delinquent properties. Example maintenance organizations 116 can include lawn mowing service organizations, lawn care organizations, roofing organizations, home siding organizations, snow removal organizations and plumbing organizations. Other maintenance organizations 116 are possible. In some examples, these maintenance organizations 116 can have a preexisting relationship (e.g., defining cost and payment terms) with the organization that has mortgaged or now owns the property, thereby allowing maintenance requests to be easily automated, as described further below.

For instance, the example database 112 is a database associated with the organization of organization server computing device 108. Database 112 can store sensor and imaging data from the delinquent properties. Database 112 can also store maintenance scores for the delinquent properties and for a plurality of maintenance categories for the delinquent properties. Database 112 can also store records of maintenance requests, maintenance procedures implemented at the delinquent properties and names of individuals or organizations that performed the requested maintenance. Database 112 can also store benchmark scores as well as other information. Database 112 can be distributed over a plurality of databases. Organization server computing device 108 can be programmed to query (e.g. using Structured Query Language, SQL) database 112 to obtain the merchant services information.

An example schema including, but not limited to, maintenance score information stored in database is shown below:
Property ID—a set or letters, numbers or other symbols that uniquely identifies a property for a mortgager;
Property status—a set of letters that specify a status of the property, either active, delinquent or REO;
Days delinquent—a number of days that the property has been delinquent;
Sensor 1 description—a text string that describes sensor 1;
Sensor 1 data pointer; a pointer to an area of returned data for sensor 1;
Sensor n description—a text string that describes sensor 1;
Sensor n data pointer; a pointer to an area of returned data for sensor n;
Imaging device 1 description—a text string that describes imaging device 1;
Imaging device 1 data pointer; a pointer to an area of returned data for imaging device 1;
Imaging device n description—a text string that describes imaging device 1;
Imaging device n data pointer; a pointer to an area of returned data for imaging device n;
Benchmark data pointer—a pointer to benchmark data for each of sensor 1 through n and imaging device 1 through n;
Maintenance categories pointer—a pointer to a list of maintenance categories for the property;
Maintenance score—a number representing an overall maintenance score for the property;
Maintenance category score pointer—a pointer to an area of maintenance scores for each maintenance category;
Maintenance status—an alphanumeric character string indicating a current maintenance status of the delinquent property.

The above schema permits the database to be queried for data such data as current maintenance status and sensor data. The schema can be bundled as a container so that the schema can be easily transferred, for example between property owners.

As an example, the following messaging format can be used between the organization server computing device 108 and the database 112 to obtain a current maintenance status for a particular property.

| | |
|---|---|
| Property ID | Maintenance Status |

As an example, the database 112 can use the following messaging format in responding to such a request.

| | | |
|---|---|---|
| Property ID | Maintenance Status | Maintenance Status |
| | | Text String |

The response message can include a text string describing a current maintenance status for the delinquent property. More, fewer, or different fields can be used.

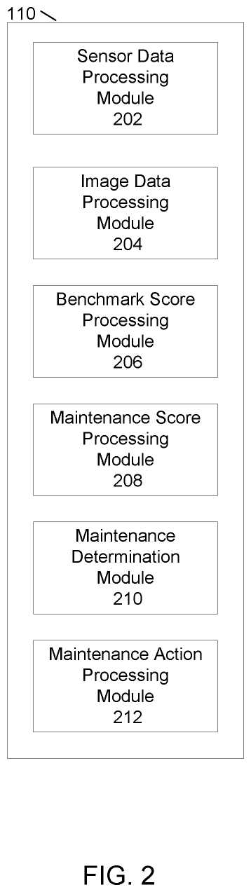

FIG. 2 shows example modules of predictive maintenance engine 110. Predictive maintenance engine 110 includes a sensor data processing module 202, an image data processing module 204, a benchmark score processing module 206, a maintenance score processing module 208, a maintenance determination module 210 and a maintenance action processing module 212. More, fewer or different modules are possible.

The example sensor data processing module 202 receives sensor data transmitted from IOT sensor devices 102. In one example implementation, for each item of sensor data received, sensor data processing module 202 identifies a category for the sensor data, for example interior temperature of a house, and sends the received value of the item of sensor data to maintenance score processing module 208. For example, if the received value of the interior temperature of the house is 82 degrees Fahrenheit, a value of 82 is sent to maintenance score processing module 208 for the interior temperature of the house.

In another example implementation, each received item of sensor data can be compared to a benchmark value and a deviation from the benchmark value can be sent to maintenance score processing module 208. For example, if the interior temperature of the house is 82 degrees Fahrenheit and the benchmark temperature is 68 degrees Fahrenheit, a value of +14 (82-68) is sent to maintenance score processing module 208 for the interior temperature of the house. Other implementations are possible.

The example image data processing module 204 receives image data transmitted from imaging sensor devices 104. Image data processing module 204 analyzes each received image, identifies an intent of each image and provides status data for the image corresponding the intent. For example, if image data processing module 204 determines that the image is of a lawn of a house, image data processing module 204 can make a determination as to the condition of the lawn and whether the lawn needs watering. Image data processing module 204 can also make an assessment of the quality of the lawn and determine whether the lawn has excessive weeds. Image data processing module 204 can also attempt to determine a status of the grass. Image data processing module 204 can then send status data regarding the lawn to maintenance score processing module 208.

For example, regarding the lawn, image data processing module 204 can send maintenance score processing module 208 three items of information—a number from 1 to 10 representing the dryness of the lawn and a number from 1 to 10 representing the quality of the lawn and a number from 1 to 10 representing the status of the grass, where a 10 identifies an extremely dry lawn, a lawn with an extreme excessive number of weeds and a lawn with very high grass that needs mowing.

The example benchmark score processing module 206 determines a benchmark score that can be used to compare against the maintenance score for the delinquent property. In one implementation, the benchmark score can equal an average maintenance score of other houses in a predetermined radius, for example 500 meters, of the delinquent property. In another implementation, the benchmark score can be based on a government benchmark score for the delinquent property, for example an expected Fannie Mae benchmark score for houses similar to the delinquent property. The Fannie Mae benchmark score can then be adjusted by adding a regional factor and a climatic factor.

The regional and climatic factors can be used to adjust the government benchmark score so that the government benchmark score can be more accurately compared with the maintenance score. The regional factor can represent an adjustment due to conditions in a region of the country in which the delinquent property is located. For example, if the delinquent property is located in the northern Midwestern area of the United States, the regional factor can adjust for conditions of snow, ice and cold temperatures. Similarly, if the delinquent property is located in the southwestern area of the United States, the regional factor can adjust for conditions of dryness and extreme heat. The climatic factors can adjust for climatic conditions at the time the government benchmark score is used. For example, an adjustment can be made to the government benchmark score based on whether the sensor and imaging data is obtained in the winter or summer.

The adjustment in the government benchmark score for the regional or climatic factors can be implementation dependent. In some implementations the government benchmark score can be adjusted by a percentage corresponding to each of the regional or climatic factors. In other implementations, individual items used to calculate the maintenance score can be adjusted, either by multiplying the individual items by a percentage or by adding or subtracting a number corresponding to the regional or climatic factors. For example, a number can be added or subtracted to the internal temperature of the delinquent property to adjust for a regional or climatic factor. Other items that contribute to the government benchmark score can be similarly adjusted. Other methods for adjusting the government benchmark score for the regional or climatic factors are possible.

An example equation for adjusting the government benchmark score based on regional and climatic factors can be:

benchmark score=Fannie Mae benchmark*(regional factor+climatic factor)

Other equations are possible.

Regional and climatic factors would not need to be applied to a benchmark score based upon based on the average maintenance score of other houses in the predetermined radius because the average maintenance scores are based on the region and climate in which the delinquent property is located.

The example maintenance score processing module 208 calculates a maintenance score for the delinquent property. The maintenance score is a number that can be compared against the benchmark score to determine a maintenance status of the delinquent property and to determine whether one or more maintenance procedures should be initiated for the delinquent property. The maintenance score can be calculated from information received from IOT sensor devices 102 and from imaging sensor devices 104.

In one example implementation, numerical data from IOT sensor devices 102 and from imaging sensor devices 104 for specific maintenance categories are added together to form the calculated maintenance score. For example, if the internal temperature and humidity of the house are two of the specific maintenance categories, numerical values of the internal temperature and the humidity, for example 75 and 48, respectively, are obtained from IOT sensor devices 102 and added together. Similarly, if the roof, lawn quality and exterior appearance of the house are maintenance categories, maintenance score processing module 208 can analyze imaging data of the roof, lawn and exterior of the building obtained from imaging sensor devices 104 and determine a numerical representation, for example from 1 to 10, for these maintenance categories, where a 10 would represent the highest score (no need for maintenance) and a 1 would represent the lowest score (low need for maintenance). Numerical scores obtained via data from imaging sensor devices 104 can be multiplied by a normalizing weighting factor and then added to the numerical scores obtained for maintenance categories from IOT sensor devices 102.

In another example implementation for calculating the maintenance score, instead of adding raw numbers (for example obtained values for temperature and humidity), the raw numbers for each maintenance category can be compared to benchmark numbers for the maintenance category and deviations from the benchmark numbers be added together. For example, an internal temperature of the delinquent property obtained from IOT sensor devices 102 can be adjusted for a regional and/or climatic factor and compared to a benchmark score for internal temperature. The deviation of the measured internal temperature from the benchmark score can then be used in calculating the maintenance score. Deviations of sensor data from other maintenance categories can be used in a similar manner and added together to arrive at an overall maintenance score for the delinquent property. Other methods of calculating the maintenance score are possible.

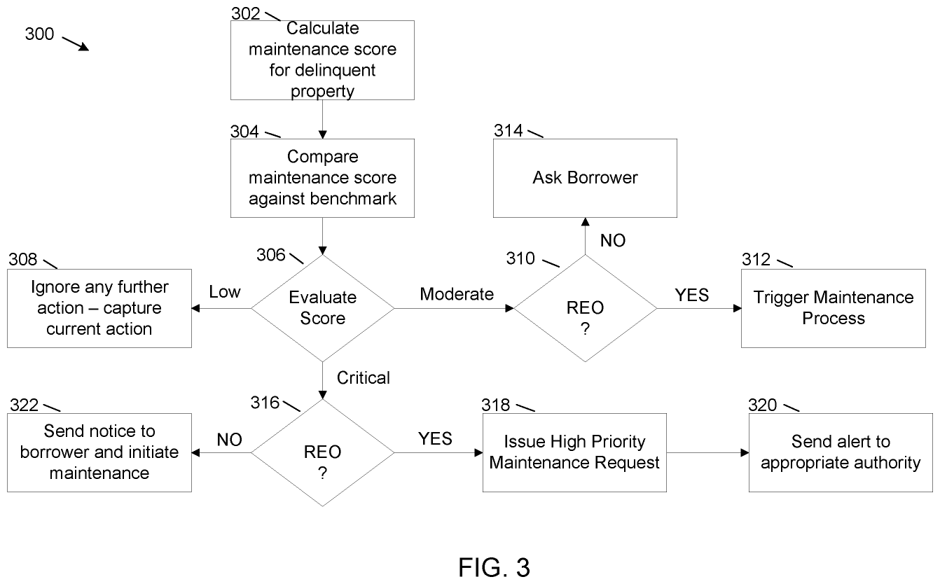

The example maintenance determination module 210 compares the maintenance score with a benchmark score to determine whether one or more maintenance procedures should be initiated at the delinquent property. A procedure used by maintenance determination module 210 is described later herein with respect to FIG. 3.

The example maintenance action processing module 212 implements an action to initiate one or more maintenance procedures at the delinquent property based on the comparison between the maintenance score and the benchmark score. The action initiated is dependent upon an amount of a deviation between the maintenance score and the benchmark score and whether the delinquent property is REO. A procedure used by maintenance action processing module 212 is described later herein with respect to FIG. 3.

FIG. 3 shows a flowchart for an example method 300 for determining when to initiate maintenance at the delinquent property and for determining maintenance actions.

At operation 302, a maintenance score is calculated for the delinquent property. As discussed earlier herein, the maintenance score can be calculated by adding numerical values obtained from IOT sensor devices 102 and from an analysis of images obtained from imaging sensor devices 104 and adjusting the calculated maintenance score based on climatic and regional factors. For method 300, the maintenance score is calculated by adding actual values of sensor data for a plurality of maintenance categories. An alternative method of adding deviations of the sensor data from benchmark scores for each of the maintenance categories is not used in method 300.

At operation 304, the maintenance score calculated in operation 302 is compared against a benchmark score for the delinquent property. For method 300, the benchmark score comprises a benchmark score for other houses in a radius of 500 meters from the delinquent property. Other radius distances can be used. An alternative method of using a Fannie Mae benchmark that is adjusted for regional and climatic factors is not used in method 300.

At operation 306 an evaluation is performed of the comparison between the maintenance score and the benchmark score. Different operations are performed based on whether a deviation between the maintenance score and the benchmark score is a low value, a moderate value or a critical value. In an example implementation, a low value can be a number between 0 and 5, a moderate value can be a number between 6 and 15 and a critical value can be a number over 15. Other definitions of low value, moderate value and critical value can be used.

At operation 306, when the deviation is a low value, at operation 308, no additional action is taken.

At operation 306, when the deviation is a moderate value, at operation 310 a determination is made as to whether the delinquent property is REO. A delinquent property that is REO is typically a foreclosed property that is owned by a real estate company or a financial institution.

When a determination is made at operation 310 that the delinquent property is REO, at operation 312 a maintenance process is triggered to initiate one or more maintenance procedures at the delinquent property.

When a determination is made at operation 310 that the delinquent property is not REO, at operation 314, the borrower is asked to initiate the one or more maintenance procedures at the delinquent property.

At operation 306, when the deviation is a critical value, at operation 316, a determination is made as to whether the delinquent property is REO.

When a determination is made at operation 316 that the delinquent property is REO, at operation 318, a high-priority maintenance request is issued. Then, at operation 320, an alert is sent to an appropriate authority, for example to Fannie Mae or the FHA.

When a determination is made at operation 316 that the delinquent property is not REO, at operation 322, a notice is sent to a mortgagee of the delinquent property and one or more maintenance procedures are initiated. The notice can inform the mortgagee of the impending maintenance.

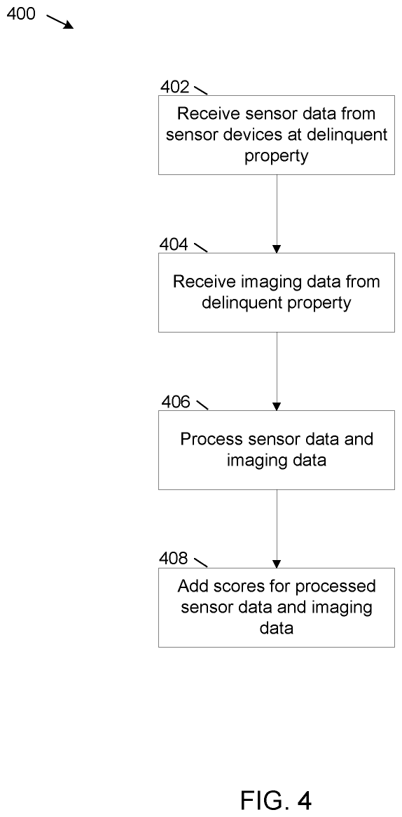

FIG. 4 shows a flowchart for example operation 302 of FIG. 3 for calculating a maintenance score for the delinquent property.

At operation 402, sensor data is received from sensor data at the delinquent property. The sensor data can originate from various IOT sensors at the delinquent property. The IOT sensors can monitor items such as interior temperature and humidity, home appliances, leaking from pipes and soil moisture.

At operation 404, imaging data is received from cameras at appropriate locations at the delinquent property. The cameras can monitor such items as a condition of the roof, siding exterior, driveway and lawn of the delinquent property.

At operation 406, predictive maintenance engine 110 processes the received sensor and imaging data. Processing the received sensor data can comprise storing the received sensor data in database 112 and can comprise adjusting the received sensor data for regional and climatic factors. Processing the received imaging data can comprise analyzing the received imaging data and assigning a number, for example from 1 to 10, to each item of imaging data. The number can indicate a degree to which the item being imaged, for example roof or lawn, is in need of maintenance, where 10 can indicate a highest need for maintenance and 1 can indicate a lowest need for maintenance.

In some implementations, processing the received sensor data can also comprise comparing received sensor data for a plurality of maintenance categories with benchmark scores for each of the plurality of maintenance categories. For these implementations, each item of sensor data can comprise a deviation between the received sensor data and the benchmark score for the maintenance category.

At operation 408, the numerical scores for each item of the processed sensor and imaging data are added to result in a maintenance score for the delinquent property. The maintenance score can then be compared against a benchmark score for the delinquent property.

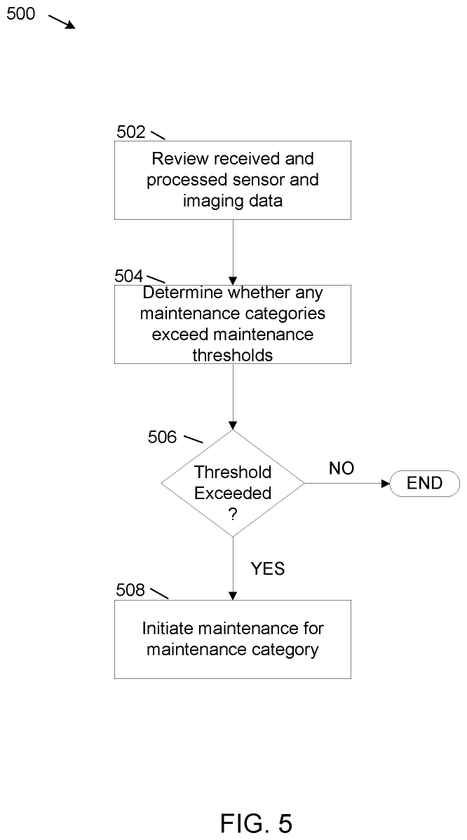

FIG. 5 shows a flowchart for a method 500 for triggering a maintenance request. Method 500 is activated when a determination is made, for example either at operation 312 or 318, that maintenance is needed for the delinquent property. A determination then needs to be made as to where the maintenance is needed. Method 500 involves identifying which item internal or external to the delinquent property is in need of maintenance.

At operation 502, the received and processed sensor and imaging data from operations 402-406 are reviewed. The review can be performed manually via an employee of the organization or, in some implementations, the review can be automatically performed via software on organization server computing device 108. The intent of the review is to identify those maintenance categories for which data is out of range, based on a standard of evaluation.

At operation 504, a determination is made as to whether sensor or imaging data for any maintenance category exceeds a predetermined threshold. For example, sensor data for a maintenance category can be compared with benchmark data for the maintenance category. Maintenance can be indicated when a deviation between the sensor data and the benchmark data exceeds the threshold for the maintenance category.

At operation 506, when a determination is made that the threshold is exceeded for a maintenance category, at operation 508, one or more requests for needed maintenance for the maintenance category are initiated.

At operation 506, when a determination is made that thresholds for remaining maintenance categories have not been exceeded, maintenance is not initiated and method 500 ends.

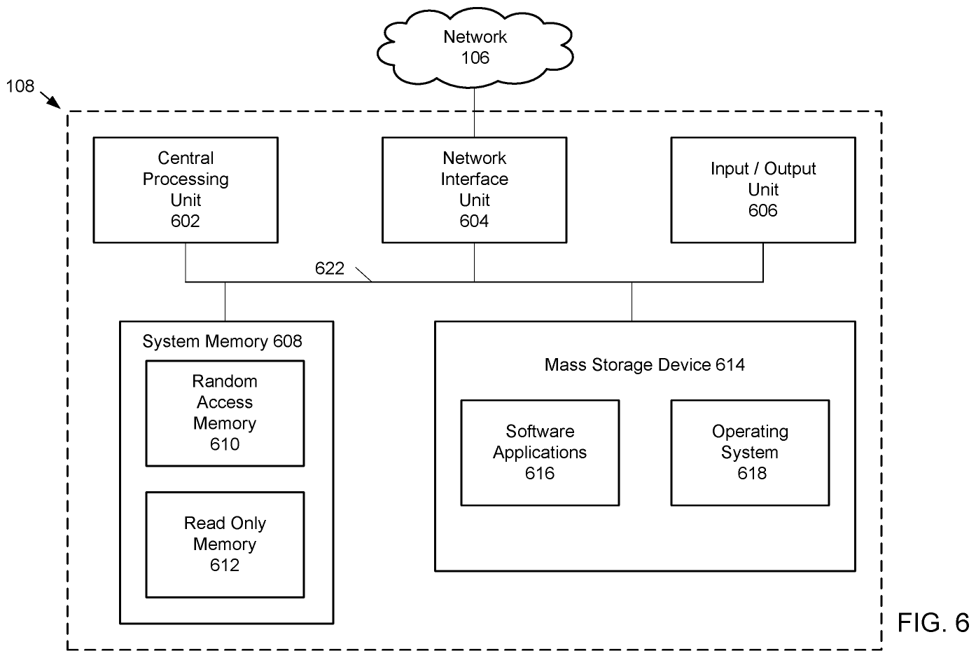

As illustrated in the example of FIG. 6, organization server computing device 108 includes at least one central processing unit (“CPU”) 602, also referred to as a processor, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between elements within the organization server computing device 108, such as during startup, is stored in the ROM 612. The organization server computing device 108 further includes a mass storage device 614. The mass storage device 614 is able to store software instructions and data.

The mass storage device 614 is connected to the CPU 602 through a mass storage controller (not shown) connected to the system bus 622. The mass storage device 614 and its associated computer-readable data storage media provide non-volatile, non-transitory storage for the organization server computing device 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the organization server computing device 108.

According to various embodiments of the invention, the organization server computing device 108 may operate in a networked environment using logical connections to remote network devices through the network 106, such as a wireless network, the Internet, or another type of network. The organization server computing device 108 may connect to the network 106 through a network interface unit 604 connected to the system bus 622. It should be appreciated that the network interface unit 604 may also be utilized to connect to other types of networks and remote computing systems. The organization server computing device 108 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the organization server computing device 108 can store software instructions and data. The software instructions include an operating system 618 suitable for controlling the operation of the organization server computing device 108. The mass storage device 614 and/or the RAM 610 also store software instructions and software applications 616, that when executed by the CPU 602, cause the organization server computing device 108 to provide the functionality of the organization server computing device 108 discussed in this document. For example, the mass storage device 614 and/or the RAM 610 can store software instructions that, when executed by the CPU 602, cause the organization server computing device 108 to display received data on the display screen of the organization server computing device 108.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device for implementing maintenance for a delinquent property, the method comprising:
monitoring environmental and conditional aspects of the delinquent property using a plurality of sensing devices coupled to a network;
sending data associated with the monitoring by one of the plurality of sensing devices through the network to a central server;
receiving, at the central server, the data from the one of the plurality of sensing devices at the delinquent property;
calculating a maintenance score based on the data received;
storing the maintenance score in a record in a database associated with the central server, the record including: an identifier of the delinquent property; a maintenance status for the delinquent property; and the maintenance score;
calculating, for the one of the plurality of sensing devices, using the data received, a deviation value for the delinquent property, the deviation value representing a difference between the maintenance score and a benchmark value, and the deviation value being related to a need for maintenance at the delinquent property;
comparing the deviation value with a predetermined threshold value for a specific maintenance category for properties within a predetermined distance from the delinquent property;
determining whether the delinquent property is a real-estate owned property;
automatically triggering a request for maintenance for the delinquent property when the deviation value is outside a scope of the predetermined threshold value, including:
when the delinquent property is the real-estate owned property and the deviation value is a critical value:
sending the request for maintenance to a maintenance organization;
initiating a high-priority maintenance request for at least one or more maintenance procedures at the delinquent property; and
sending an alert to an appropriate federal or local authority regarding the critical value of the deviation value; and
when the delinquent property is other than the real-estate owned property, sending a request to initiate a maintenance procedure to a borrower associated with the delinquent property.

2. The method of claim 1, further comprising:
determining a number of days the delinquent property has been delinquent; and
calculating the deviation value when the delinquent property has been delinquent for at least a predetermined number of days.

3. The method of claim 1, wherein the data received includes data relating to one or more of: a temperature in a building on the delinquent property, soil moisture and humidity, lawn quality and water leakage.

4. The method of claim 1, further comprising receiving images from one or more cameras located inside or outside the delinquent property.

5. The method of claim 4, further comprising:
using the images to determine a status of one or more items at the delinquent property;
assigning a value for each status that is representative of the status; and
and using the value for each status in conjunction with the data received to calculate the deviation value.

6. The method of claim 5, further comprising calculating an overall maintenance score by adding the value of each status to the data received.

7-9. (canceled)

10. The method of claim 1, wherein the benchmark value includes a regional factor based on a region in which the delinquent property is located and a climatic factor based on climatic conditions in the region at a time period when the deviation value is calculated.

11. The method of claim 6, wherein an overall deviation value for the delinquent property is proportional to the data received, a regional factor, a climatic factor, and the value for each status based on one or more images captured from the delinquent property, wherein the regional factor is based on a region in which the delinquent property is located and the climatic factor is based on climatic conditions in the region at a time period when the deviation value is calculated.

12. (canceled)

13. A method implemented on an electronic computing device for implementing maintenance for a delinquent property, the method comprising:
monitoring environmental and conditional aspects of the delinquent property using a plurality of sensing devices coupled to a network;
sending data associated with the monitoring by one of the plurality of sensing devices through the network to a central server;
receiving, at the central server, the data from the one of the plurality of sensing devices at the delinquent property;
storing the data in a record in a database associated with the central server, the record including: an identifier of the delinquent property; a maintenance status for the delinquent property; and a maintenance score;
receiving one or more images of the delinquent property from one of a plurality of cameras located inside or outside the delinquent property;
identifying a plurality of maintenance categories for the delinquent property;
associating each of the plurality of maintenance categories with the data received and/or the one or more images from the plurality of sensing devices and the plurality of cameras;
using the data received and the one or more images to calculate a numerical value for each of the plurality of maintenance categories;
for each of the plurality of maintenance categories, calculating a deviation value representing a difference between the numerical value and a benchmark value for each of the plurality of maintenance categories, wherein the benchmark value is an average benchmark value for each of the plurality of maintenance categories for properties within a predetermined distance from the delinquent property, and the deviation value is related to a need for maintenance at the delinquent property;
comparing the deviation value with a predetermined threshold for a specific maintenance category;
determining whether the delinquent property is a real-estate owned property;
when the deviation value is above the predetermined threshold and the delinquent property is other than the real-estate owned property:
automatically triggering a review request for maintenance at the delinquent property; and
sending the review request to a borrower of the delinquent property; and
when the deviation value is above the predetermined threshold at a critical value and the delinquent property is the real-estate owned property:
automatically triggering a request for maintenance at the delinquent property;
sending the request for maintenance to a maintenance organization;
initiating a high-priority maintenance request for at least one or more maintenance procedures at the delinquent property; and
sending an alert to an appropriate federal or local authority regarding the critical value of the deviation value.

14. (canceled)

15. The method of claim 13, wherein the benchmark value for the delinquent property is further based on a government benchmark value.

16. The method of claim 15, wherein the government benchmark value is modified by a regional factor and a climatic factor, wherein the regional factor is based on a region in which the delinquent property is located and the climatic factor is based on climatic conditions in the region at a time period when the deviation value is calculated.

17-19. (canceled)

20. An electronic computing device comprising:
a processor; and
a system memory, the system memory including instructions which, when executed by the processor, cause the electronic computing device to:
monitor environmental and conditional aspects of a delinquent property using a plurality of sensing devices coupled to a network;
send data associated with the monitoring by one of the plurality of sensing devices through the network to a central server;
receive, at the central server, the data from the one of the plurality of sensing devices at the delinquent property;
calculate a maintenance score based on the data received;
store the maintenance score in a record in a database associated with the central server, the record including: an identifier of the delinquent property; a maintenance status for the delinquent property; and the maintenance score;
associate the data received with one or more maintenance categories;
based on the data received, determine a deviation value for each of the one or more maintenance categories, the deviation value representing a difference between the maintenance score and a benchmark value, and the deviation value being related to a need for maintenance;
receive images from one of a plurality of cameras at the delinquent property;
associate each image with a numerical value for each of the one or more maintenance categories;
based on an analysis of each of the images, determine the deviation value for each of the one or more maintenance categories;
obtain a predetermined threshold for property maintenance, the predetermined threshold for property maintenance based on an average benchmark value for each of the one or more maintenance categories for homes within a predetermined radius of the delinquent property;
compare the deviation value for each of the one or more maintenance categories for the delinquent property with the predetermined threshold;
determine whether the delinquent property is a real-estate owned property; and
based on the comparison, automatically trigger a request for maintenance for the delinquent property when the deviation value is outside a scope of the predetermined threshold, including:
when the delinquent property is the real-estate owned property and the deviation value is a critical value:
send the request for maintenance to a maintenance organization;
initiate a high-priority maintenance request for at least one or more maintenance procedures at the delinquent property; and
send an alert to an appropriate federal or local authority regarding the critical value of the deviation value; and
when the delinquent property is other than the real-estate owned property, send a request to initiate a maintenance procedure to a borrower associated with the delinquent property.

21. The method of claim 1, further comprising calculating an overall deviation value by adding the deviation value calculated for each of the data received.

22. The method of claim 13, wherein the data received includes data relating to one or more of: a temperature in a building on the delinquent property, soil moisture and humidity, lawn quality, and water leakage.

23. The method of claim 13, wherein when subsequent to sending the review request for maintenance to the borrower of the delinquent property, a determination is made that maintenance is required, automatically sending the request to the maintenance organization.

24. The electronic computing device of claim 20, further comprising wherein when the deviation value is less than the predetermined threshold, no request is triggered.
